(19) United States
(12) Patent Application Publication
(10) Pub. No.: US 2008/0119223 A1
(43) Pub. Date: May 22, 2008

(54) Mobile Telephone

(75) Inventor: Hiroshi Tsunoda, Kadoma-shi (JP)

Correspondence Address: KRATZ, QUINTOS & HANSON, LLP, 1420 K Street, N.W., Suite 400, WASHINGTON, DC, 20005, US

(73) Assignee: Sanyo Electric Co., Ltd., Moriguchi-shi (JP)

(21) Appl. No.: 11/596,411

(22) PCT Filed: Apr. 28, 2005
(86) PCT No.: PCT/JP05/08189

§ 371 Date: Aug. 2, 2007

(30) Foreign Application Priority Data
May 13, 2004 (JP) 2004-143888

(51) Int. Cl. H04M 1/00

(52) U.S. Cl. 455/556.1

(57) ABSTRACT

When transmitting image data photographed using a camera mounted on a mobile phone to a PC connected with the camera, if an incoming-call is received and a call starts, the photographing cannot be continued. A user of the PC cannot find such state. Storage unit 101 stores first image data indicating reception of an incoming-call and second image data indicating that a call is in progress. An image photographed by camera unit 102 is compression-coded by JPEG compression unit 103, and is stored in image data storage unit 104 in units of frames. Control unit 112 reads the image data to meet a predetermined transmission rate, and transmits the image data to host PC 120 via I/F 113. Upon receiving notification of an incoming-call from base band signal processing unit 108, control unit 112 causes camera unit 102 stop photographing, reads the first image data from storage unit 101, and transmits the first image data to host PC 120. Upon receiving notification of a call start from operation unit 105, control unit 112 reads the second image data from storage unit 101, and transmits the second image data to host PC 120.

### FIELD OF THE INVENTION

The present invention relates to a mobile phone equipped with a camera, particularly to an art for transmitting an image photographed using the camera to another personal computer (hereinafter “PC”) via a PC connected with the camera.

### BACKGROUND ART

Connection shown in FIG. 7 has been input into practical use. Specifically, in FIG. 7, a camera 703 is connected with a host PC 702 connected to a network server 701, and an image photographed by the camera 703 is transferred to another PC 704. The USB (Universal Serial Bus) standard is applied to the connection between the camera 703 and the host PC 702, for example. The image is transferred as compression-coded image data in accordance with the JPEG (Joint Photographic Coding Experts Group) specification in order to use a network band effectively. And the image photographed by the camera 703 is displayed on a screen of another PC 704. An image transfer art between PCs is disclosed in Japanese Patent Application Publication No. 2003-134486, for example.

Also, many recent mobile phones have a camera equipped therewith. Furthermore, some mobile phones can be connected to PCs via a USB cable, etc. The above-mentioned transfer of photographed image data between PCs via a network is available by using cameras of mobile phones.

### DISCLOSURE OF THE INVENTION

### Problem the Invention is Going to Solve

However, suppose that a user of a mobile phone receives an incoming-call while photographing an image using a camera of the mobile phone. If the user continues photographing the image, the user cannot start a call.

However, a phone function needs to be prioritized in mobile phones. When the user starts the call using the mobile phone, the photographing is stopped and thereby image data photographed by the camera cannot be transmitted to a PC connected with the camera. As a result, transfer of the image data from the PC to another PC is stopped, and accordingly an image based on the image data cannot be displayed on another PC. This makes a user of another PC worry that some troubles might have occurred.

Also, there is a situation where the user does not want to transmit an image being photographed to another PC.

In view of the above problems, the present invention aims to provide a mobile phone that transmits an image indicating a use state of the mobile phone to a PC connected with a camera of the mobile phone and another PC connected via a network in order to display the image, when photographing using the camera is stopped or when an incoming-call is received and a call starts.

### Means for Solving the Problem

In order to solve the above problems, the present invention is a mobile phone connected with a computer, comprising: a camera operable to photograph a subject; an image compression unit operable to compress image data obtained by photographing the subject; a transmission unit operable to transmit the compressed image data to the computer at a predetermined transmission rate; a storage unit operable to store prepared alternate image data indicating that the photographing is stopped; a judgment unit operable to determine whether to stop the photographing and whether to restart the photographing; and a control unit operable, if the judgment unit determines to stop the photographing, to cause the camera to stop photographing and cause the transmission unit to transmit the alternate image data instead of the compressed image data, and if the judgment unit determines to restart the photographing, to cause the camera to restart photographing and cause the transmission unit to transmit the compressed image data instead of the alternate image data.

### Effect of the Invention

With the above structure, even if photographing is stopped, alternate image data can be transmitted instead of photographed image data at a predetermined transmission rate. Therefore, any image can be continuously displayed on a computer connected with a camera of a mobile phone.

Also, the alternate image data includes first image data indicating that an incoming-call is incoming and second image data indicating that a call is in progress, and the judgment unit judges which has occurred among reception of the incoming-call, start of the call, and end of the call, if the judgment unit judges that the incoming-call has been received, the control unit causes the camera to stop photographing and causes the transmission unit to transmit the first image data instead of the compressed image data, if the judgment unit judges that the call has started, the control unit causes the transmission unit to transmit the second image data instead of the first image data, and if the judgment unit judges that the call has ended, the control unit causes the camera to restart photographing, and causes the transmission unit to transmit the compressed image data instead of the second image data.

With the above structure, when an incoming-call is received in a mobile phone, a first image indicating that the incoming-call has been received is displayed instead of an image photographed by a camera on a computer connected with the camera of the mobile phone. When a call starts, a second image indicating that the call has started is displayed on the computer. When the call ends, the image photographed by the camera is displayed on the computer again. Therefore, a user of the computer can find a use state of the mobile phone.

Also, the computer notifies the mobile phone of the predetermined transmission rate.

With the above structure, the photographed image can be continuously displayed on a screen of the computer.

Also, the computer transmits the compressed image data, the first image data, and the second image data that are received from the mobile phone to another computer via a network, and another computer decodes and displays the image data, the first image data, and the second image data.

With the above structure, a photographed image and a use state of the mobile phone can be displayed on another computer via a network.

Also, the image compression unit compresses the first image data and the second image data such that a data amount thereof is sufficiently small that a communication function is not affected.

With the above structure, the computer connected with the camera of the mobile phone and another computer can be notified of the use state of the mobile phone via a network. Therefore, the computer and another computer can be notified of a state where photographing is being stopped while maintaining a call using the mobile phone.

Also, the first image data includes a message indicating that the incoming-call is incoming, and the second image data includes a message indicating that the call is in progress.

With the above structure, a state where an incoming-call is incoming and a call is in progress can be clearly displayed on the screen of the computer connected with the camera of the mobile phone.

Also, the first image data is any one of a plurality of pieces of first image data and has been selected from among the pieces of first image data by a user of the mobile phone, and the second image data is any one of a plurality of pieces of second image data and has been selected from among the pieces of second image data by the user.

With the above structure, the user can select a prepared image indicating that an incoming-call is incoming or a call is in progress.

### BRIEF DESCRIPTION OF THE DRAWINGS

FIG. 1 is a block diagram of an embodiment of a mobile phone according to the present invention;

FIG. 2 shows an example of first image data stored in a storage unit in the embodiment;

FIG. 3 shows an example of second image data stored in the storage unit in the embodiment;

FIG. 4 is a conceptual diagram showing image transfer between PCs using a camera of the mobile phone in the embodiment;

FIG. 5 is a conceptual diagram showing image transfer between the PCs when the mobile phone shown in FIG. 4 in the embodiment receives an incoming-call and a call starts;

FIG. 6 is a flow chart describing operations in the embodiment; and

FIG. 7 is a conceptual diagram showing image transfer between PCs using a conventional camera.

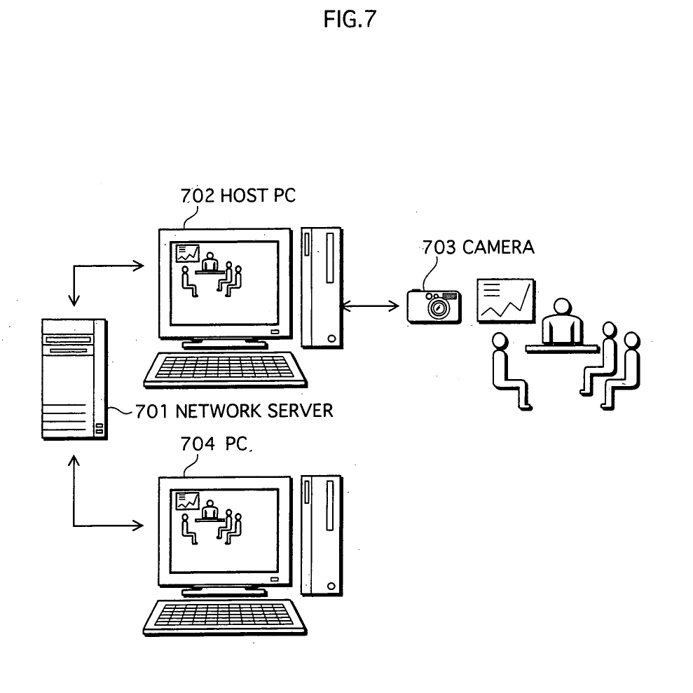

### DESCRIPTION OF CHARACTERS

100: mobile phone
101: storage unit
102: camera unit
103: JPEG compression unit
104: image data storage unit
105: operation unit
106: antenna
107: wireless unit
108: base band signal processing unit
109: speaker
110: microphone
111: display unit
112: control unit
113: USB I/F of the mobile phone 100
120: host PC
121: USB I/F of the host PC 120
130: network
140: PC

### BEST MODE FOR CARRYING OUT THE INVENTION

The following describes an embodiment of a mobile phone according to the present invention with reference to the drawings.

### EMBODIMENT

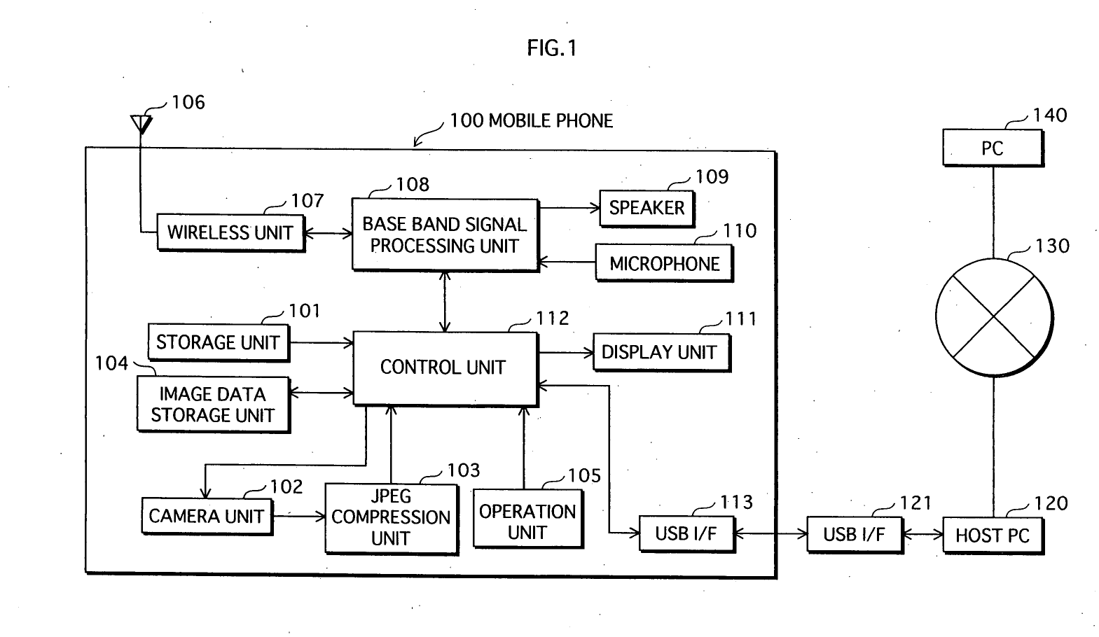

FIG. 1 is a block diagram of the embodiment of the mobile phone according to the present invention.

A mobile phone 100 includes a storage unit 101, a camera unit 102, a JPEG compression unit 103, an image data storage unit 104, an operation unit 105, an antenna 106, a wireless unit 107, a base band signal processing unit 108, a speaker 109, a microphone 110, a display unit 111, a control unit 112, and a USB I/F 113 of mobile phone.

The USB I/F 113 of the mobile phone 100 is connected with a USB I/F 121 of a host PC 120. The host PC 120 is connected with another PC 140 via a network 130.

The storage unit 101 includes a semiconductor flash memory for example, and stores beforehand a plurality of pieces of alternate image data including first image data and second image data that indicate a use state of the mobile phone 100.

The first image data is obtained by compression-coding an image indicating that an incoming-call has been received by the mobile phone 100, in accordance with the JPEG specification.

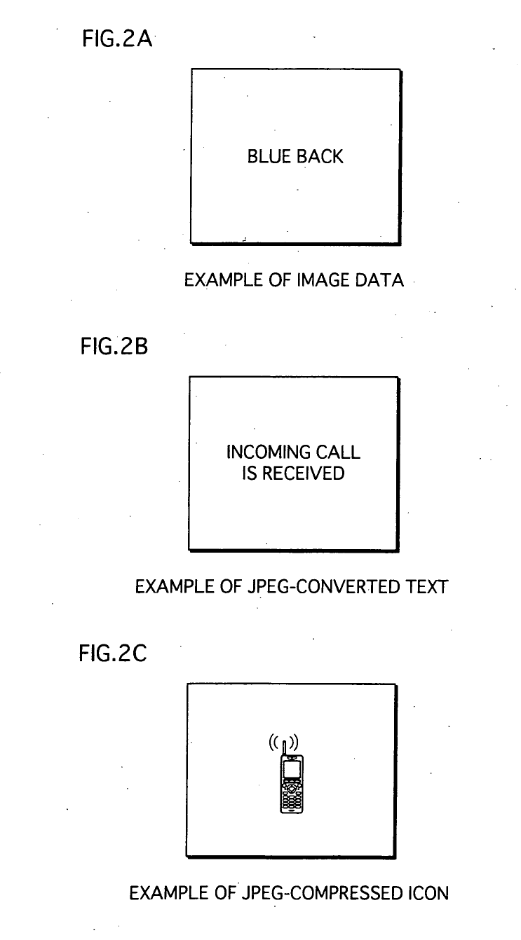

FIG. 2A to FIG. 2C each shows an example of an image obtained by extending and decoding the first image data.

In FIG. 2A, a full blue back screen indicates that an incoming-call has been received in the mobile phone 100. In FIG. 2B, a message “incoming-call is received” is shown. In FIG. 2C, an icon represents a state where an electric wave reaches an antenna of a mobile phone. This icon indicates that an incoming-call has been received in the mobile phone 100.

The second image data is obtained by compression-coding an image indicating that a call is in progress in the mobile phone 100, in accordance with the JPEG specification.

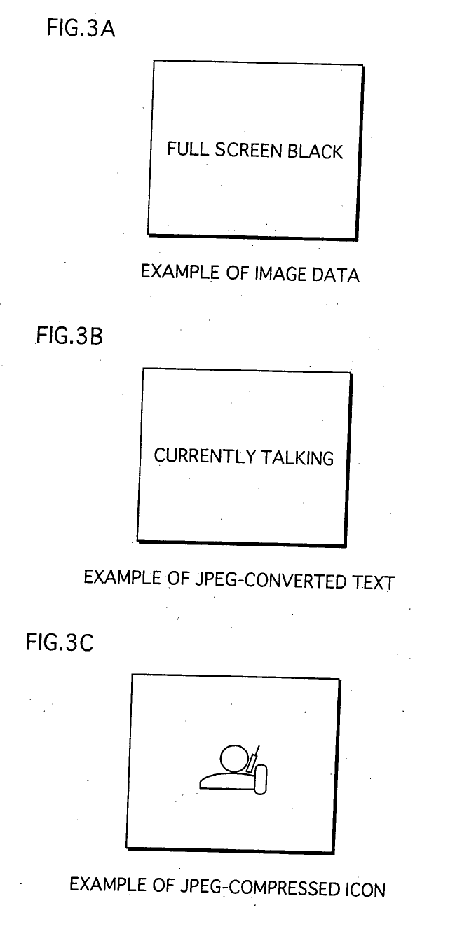

FIG. 3A to FIG. 3C each shows an example of an image obtained by extending and decoding the second image data.

In FIG. 3A, a full black screen indicates that a call is in progress in the mobile phone 100. In FIG. 3B, a message “currently calling” is shown. In FIG. 3C, an icon represents a state where a user is calling with a speaker of a mobile phone being held to his ear. This icon indicates that a call is in progress in the mobile phone 100.

The camera unit 102 includes a lens and a light receiving device, such as a CCD (Charge Coupled Device) sensor and a CMOS (Complementary Metal Oxide Semiconductor) sensor. The camera unit 102 photographs a subject, and inputs image data obtained by photographing the subject to the JPEG compression unit 103. In addition, the camera unit 102 receives notification of a transmission rate for the image data to be transmitted from the control unit 112 to the host PC 120, and photographs the subject in accordance with image data to be transmitted in units of frames.

The JPEG compression unit 103 compression-codes the image data input by the camera unit 102 in accordance with the JPEG specification, and stores the compression-coded image data in the image data storage unit 104 via the control unit 112.

The image data storage unit 104 includes a semiconductor memory such as a RAM, and stores the image data in units of frames that is photographed by the camera unit 102 and compression-coded by the JPEG compression unit 103.

The operation unit 105 includes a dialing key, an off-hook key, an on-hook key, etc., and notifies the control unit 112 of an operation signal of each key.

The antenna 106 receives a communication signal transmitted from a base station (not shown), notifies the wireless unit 107 of the communication signal, and transmits a communication signal notified from the wireless unit 107 to the base station.

The wireless unit 107 demodulates the communication signal notified from the antenna 106, and notifies the base band signal processing unit 108 of the demodulated communication signal. Also, the wireless unit 107 modulates the communication signal notified from the base band signal processing unit 108, and notifies the antenna 106 of the modulated communication signal.

If the communication signal notified from the wireless unit 107 is an incoming-call signal, the base band signal processing unit 108 notifies the control unit 112 that an incoming-call has been received. If the communication signal is an audio-signal, the base band signal processing unit 108 outputs the audio signal to the speaker 109. If the communication signal is an image signal or a text signal, the base band signal processing unit 108 notifies the control unit 112 of the image signal or the text signal. Also, the base band signal processing unit 108 processes an audio signal notified from the microphone 110, and notifies the wireless unit 107 of the processed audio signal. Also, the base band signal processing unit 108 processes an operation signal notified from the operation unit 105 via the control unit. 112, and notifies the wireless unit 107 of the processed operation signal.

The speaker 109 outputs the audio signal notified from the base band signal processing unit 108 as a sound.

The microphone 110 collects voices of the user, and notifies the base band signal processing unit 108 of the voices as an audio signal.

The display unit 111 includes a liquid crystal display, and displays, under control of the control unit 112, received information, operations performed by the operation unit 105, and an image of a subject photographed by the camera unit 102.

The control unit 112 includes a CPU and a work memory, and controls each structure of the mobile phone 100.

When the USB I/F 113 and the USB I/F 121 are connected with each other via a USB cable, the control unit 112 receives notification of a predetermined transmission rate for image data from the host PC 120. The predetermined transmission rate is 7.5 frames/sec, for example. The control unit 112 stores the transmission rate, and notifies the camera unit 102 of the predetermined transmission rate to request the camera unit 102 to photograph a corresponding image.

Also, upon receiving a camera start instruction from the host PC 120 via the USB I/F 113 and the USB I/F 121, the control unit 112 instructs the camera unit 102 to start photographing the subject. In the same way, upon receiving a camera end instruction, the control unit 112 instructs the camera unit 102 to end the photographing.

Upon receiving notification of the compressed image data from the JPEG compression unit 103, the control unit 112 temporarily stores the image data in the image data storage unit 104, reads the image data in units of frames at the predetermined transmission rate, and transmits the image data to the host PC 120 via the USB I/F 113 and the USB I/F 121.

Also, during the above transmission of the image data to the host PC 120, if notification is received indicating that the incoming-call has been received, from the base band signal processing 108, the control unit 112 stops the transmission of the image data, and instructs the camera unit 105 to stop photographing. Also, the control unit 112 reads one piece of the first image data stored in the storage unit 101, and transmits the read first image data to the host PC 120 via the USB I/F 113 and the USB I/F 121 at the predetermined transmission rate.

During the transmission of the first image data, if notification of an on-hook signal is received from the operation unit 105, the control unit 112 stops the transmission of the first image data, reads one piece of the second image data stored in the storage unit 101, and transmits the read second image data to the host PC 120 via the USB I/F 113 and the USB I/F 121 at the predetermined transmission rate.

During the transmission of the second image data, if notification of an on-hook signal is received from the operation unit 105, the control unit 112 stops the transmission of the second image data, instructs the camera unit 102 to restart photographing. Also, the control unit 112 stores the compressed image data notified from the JPEG compression unit 103 in the image data storage unit 104, reads the image data whose photographing is being stopped, and transmits the read image data to the host PC 120 via the USB I/F 113 and the USB I/F 121 at the predetermined transmission rate.

In addition, the control unit 112 may receive user's selection from the operation unit 105 to transmit which one piece of the plurality of first image data to the host PC 120. In the same way, the control unit 112 may receive user's selection from the operation unit 105 to transmit which one piece of the plurality of second image data to the host PC 120. In this case, the control unit 112 sequentially displays the plurality of first data and second image data stored in the storage unit 101 on the display unit 111, and receives selection from the user.

The USB I/F 113 of the mobile phone 100 is connected with the USB I/F 121 of the host PC 120 via the USB cable, and transmits one piece of image data, the first image data, and the second image data that are output by the control unit 112, to the host PC 120, and notifies the control unit 112 of a transmission rate output by the host PC 120 and information relating to a camera start instruction.

When the USB I/F-121 is connected with the USB I/F 113 via the USB cable, the host PC 120 transmits a transmission rate for transmission of image data from the mobile phone 100 to the host PC 120, to the mobile phone 100. Also, upon receiving a camera start instruction from an operation unit (not shown) of the host PC 120, the host PC 120 instructs the mobile phone 100 to start the camera unit 102 via the USB I/F 113 and the USB I/F 121.

Upon receiving one piece of the image data, the first image data, and the second image data from the mobile phone 100 via the USB I/F 113 and the USB I/F 121, the host PC 120 displays the received image data on a display unit thereof, and transfers the image data to another PC 140 via the network 130.

Upon receiving the image data transferred from the host PC 120 via the network 130, another PC 140 displays the received image data on a display unit thereof.

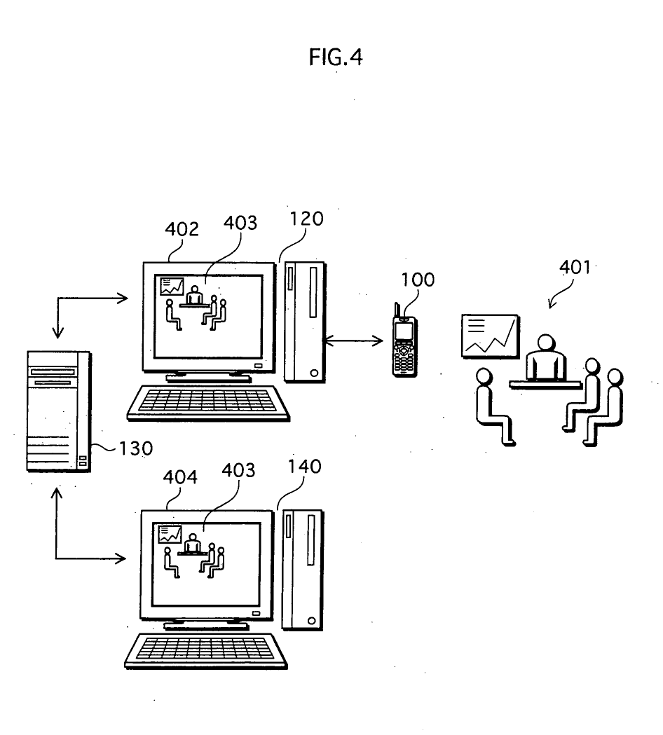

FIG. 4 is a conceptual diagram showing image transfer. In FIG. 4, a subject 401 is photographed by the camera of the mobile phone 100, image data obtained by photographing the subject 401 is transmitted to the host PC 120, an image 403 relating to the image data is displayed on the display unit of the host PC 120. Furthermore, the host PC 120 transfers the image data to another PC 140 via a network server (the network 130). The image 403 is displayed on a display unit 404 of another PC 140.

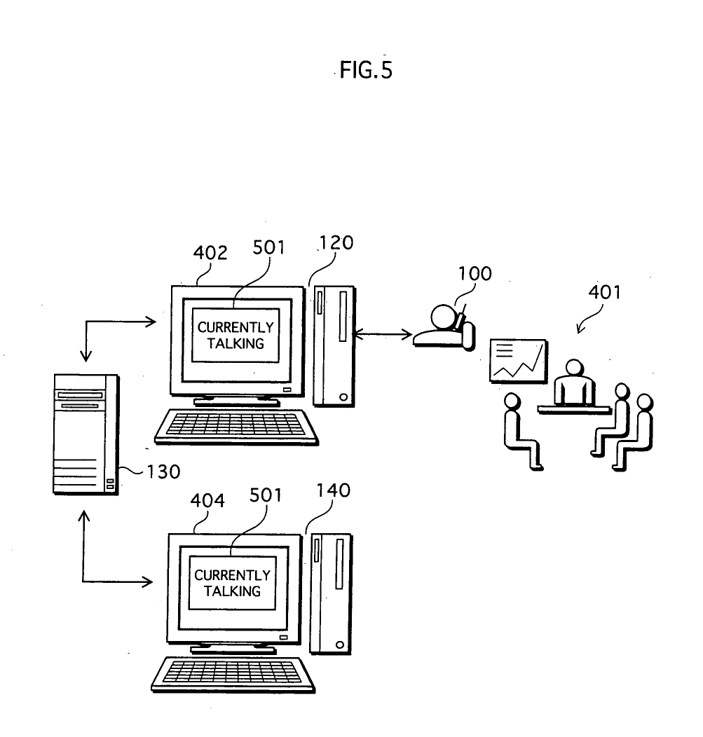

FIG. 5 is a conceptual diagram showing a state where an incoming-call is received in the mobile phone 100 shown in FIG. 4, and the user starts a call. The camera of the mobile phone 100 cannot photograph the subject 401. A second image 501 that indicates the above use state is displayed on the display unit 402 of the host PC 120 and the display unit 404 of another PC 140.

As a result, a user watching the second image 501 displayed on the host PC 120 or another PC 140 can find a state where the camera is currently disable.

In addition, when an incoming-call is received or a call is in progress in the mobile phone 100, the control unit 112 transmits the first image data or the second image data to the host PC 120 via the USB I/F 113 and the USB I/F 121 at the predetermined transmission rate. Since an amount of data to be transmitted is little, the control unit 112 is not influenced by the data amount.

Moreover, the base band signal processing unit 108 is a compositional element different from the control unit 112 in the block diagram (FIG. 1) in the embodiment. However, the two units may be mounted as a single base band chip on the mobile phone 100.

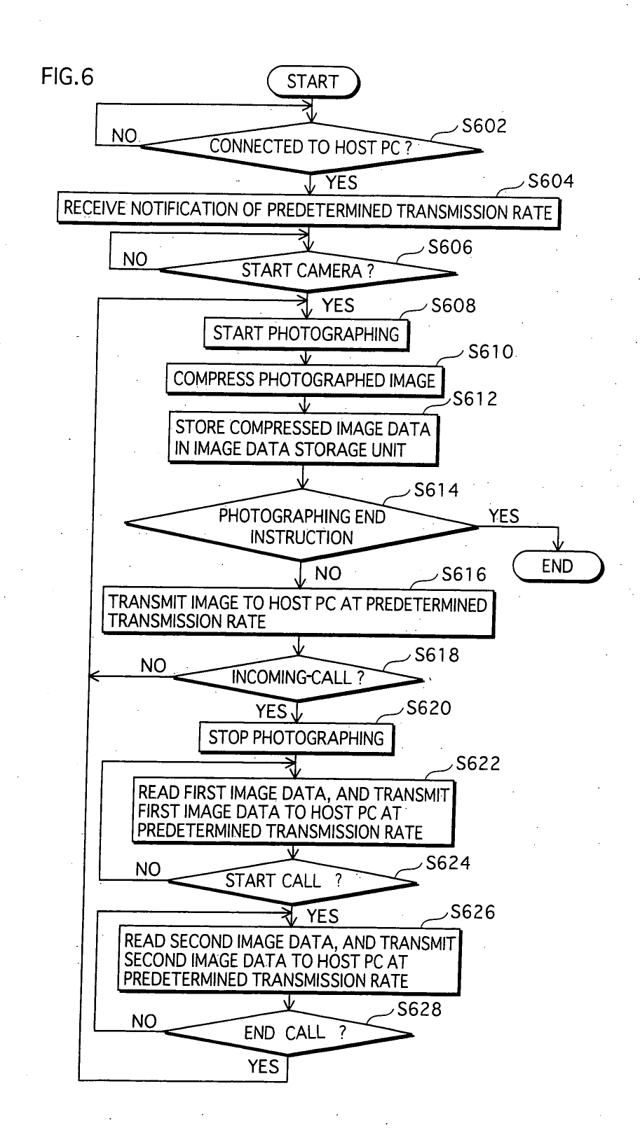

The following describes the operations in the embodiment using a flow chart shown in FIG. 6.

First, if the control unit 112 of the mobile phone 100 is connected with the host PC 120 via the USB cable (S602: Y), the control unit 112 receives notification of a predetermined transmission rate for image data from the host PC 120, notifies the camera unit 102 of the predetermined transmission rate, and stores the predetermined transmission rate therein (S604). Upon receiving a camera start instruction from the host PC 120 (S606: Y), the control unit 112 instructs the camera unit 102 to photograph.

The camera unit 102 starts photographing (S608). The JPEG compression unit 103 converts image photographed by the camera unit 102 into image data compressed in accordance with the JPEG specification, and notifies the control unit 112 of the compressed image data (S610).

The control unit 112 stores the image data in units of frames in the image data storage unit 104 (S612).

Next, the control unit 112 judges whether a photographing end instruction is received from the host PC 120 (S614). If the photographing end instruction is received, the processing ends. If the photographing end instruction is not received, the control unit 112 reads the image data from the image data storage unit 104, and transmits the image data to the host PC 120 at the predetermined transmission rate stored therein (S616).

The control unit 112 repeats the processing from Steps S608 to S616 until notification that an incoming-call has been received from the base band signal processing unit 108 (S618). If the notification of the incoming-call is received, the control unit 112 instructs the camera unit 102 to stop photographing.

The camera unit 102 stops photographing (S620).

The control unit 112 reads selected one piece of the first image data from the storage unit 101, and transmits the selected first image data to the host PC 120 at the predetermined transmission rate (S622).

The control unit 112 repeats the processing of Step S622 until notification of an off-hook signal indicating that a call has started from the operation unit 105 (S624). Upon receiving the notification of the off-hook signal, the control unit 112 reads selected one piece of the second image data from the storage unit 101 instead of the first image data, and transmits the selected second image data to the host PC 120 at the predetermined rate (S626).

Upon receiving notification of an on-hook signal indicating that the call has ended from the operation unit 105 (S628), the control unit 112 stops the transmission of the second image data, and the processing returns to Step S608. The control unit 112 repeats the processing of Step S626 until notification of the off-hook signal has been received.

In the above description of the embodiment, the camera unit 102 stops photographing when the incoming-call is received in the mobile phone 100. However, the above embodiment can be applied to a situation where the user does not want to show an image on the PC 120 and another PC 140 while photographing the image, for example.

For example, the following may be employed. Alternate image data representing a message “busy” is stored in the storage unit 101. Upon receiving notification of an operation signal of a specific key “#” button included in the operation unit 105 of the mobile phone 100, the control unit 112 causes the camera unit 102 to stop photographing, and transmits the alternate image data representing “busy” instead of photographed image data to the host PC 120 at the predetermined transmission rate.

Moreover, in the above embodiment, transmission of image data is performed in accordance with a transmission rate determined by notification of a transmission rate for the image data from the host PC 120 to the mobile phone 100. However, the above notification of the transmission rate is not necessary, and the mobile phone 100 may transmit image data at a transmission rate specific to the mobile phone 100.

Moreover, in the above embodiment, the mobile phone equipped with the camera is described. However, a mobile terminal having a communication function and having a camera mounted thereon may be employed.

Moreover, the structure of the above embodiment is shown in FIG. 1. However, a program that causes a computer to execute each compositional element may realize the present invention.

### INDUSTRIAL APPLICABILITY

A mobile phone according to the present invention can be easily used as a camera that photographs an image to be transferred among network-connected PCs.

1. A mobile phone connected with a computer, comprising:
a camera operable to photograph a subject;
an image compression unit operable to compress image data obtained by photographing the subject;
a transmission unit operable to transmit the compressed image data to the computer at a predetermined transmission rate;
a storage unit operable to store prepared alternate image data indicating that the photographing is stopped;
a judgment unit operable to determine whether to stop the photographing and whether to restart the photographing; and
a control unit operable, if the judgment unit determines to stop the photographing, to cause the camera to stop photographing and cause the transmission unit to transmit the alternate image data instead of the compressed image data, and if the judgment unit determines to restart the photographing, to cause the camera to restart photographing and cause the transmission unit to transmit the compressed image data instead of the alternate image data.

2. The mobile phone of claim 1, wherein
the alternate image data includes first image data indicating that an incoming-call is incoming and second image data indicating that a call is in progress, and
the judgment unit judges which has occurred among reception of the incoming-call, start of the call, and end of the call,
if the judgment unit judges that the incoming-call has been received, the control unit causes the camera to stop photographing and causes the transmission unit to transmit the first image data instead of the compressed image data,
if the judgment unit judges that the call has started, the control unit causes the transmission unit to transmit the second image data instead of the first image data, and
if the judgment unit judges that the call has ended, the control unit causes the camera to restart photographing, and causes the transmission unit to transmit the compressed image data instead of the second image data.

3. The mobile phone of claim 1, wherein
the computer notifies the mobile phone of the predetermined transmission rate.

4. The mobile phone of claim 2, wherein
the computer transmits the compressed image data, the first image data, and the second image data that are received from the mobile phone to another computer via a network, and
the another computer decodes and displays the image data, the first image data, and the second image data.

5. The mobile phone of claim 2, wherein
the image compression unit compresses the first image data and the second image data such that a data amount thereof is sufficiently small that a communication function is not affected.

6. The mobile phone of claim 5, wherein
the first image data includes a message indicating that the incoming-call is incoming, and the second image data includes a message indicating that the call is in progress.

7. The mobile phone of claim 6, wherein
the first image data is any one of a plurality of pieces of first image data and has been selected from among the pieces of first image data by a user of the mobile phone, and the second image data is any one of a plurality of pieces of second image data and has been selected from among the pieces of second image data by the user.
